(19) United States
(12) Patent Application Publication
(10) Pub. No.: US 2023/0064692 A1
(43) Pub. Date: Mar. 2, 2023

(54) Network Space Search for Pareto-Efficient Spaces

(71) Applicant: MediaTek Inc., Hsinchu City (TW)

(72) Inventors: Hao Yun Chen, Hsinchu City (TW); Min-Hung Chen, Hsinchu City (TW); Min-Fong Horng, Hsinchu City (TW); Yu-Syuan Xu, Hsinchu City (TW); Hsien-Kai Kuo, Hsinchu City (TW); Yi-Min Tsai, Hsinchu City (TW)

(21) Appl. No.: 17/846,007

(22) Filed: Jun. 22, 2022

Related U.S. Application Data
(60) Provisional application No. 63/235,221, filed on Aug. 20, 2021.

(51) Int. Cl. G06N 3/04; G06N 3/08; G06N 3/063; G06N 7/00

(52) U.S. Cl. CPC G06N 3/04; G06N 3/08; G06N 3/063; G06N 7/005

(57) ABSTRACT

According to a network space search method, an expanded search space is partitioned into multiple network spaces. Each network space includes a plurality of network architectures and is characterized by a first range of network depths and a second range of network widths. The performance of the network spaces is evaluated by sampling respective network architectures with respect to a multi-objective loss function. The evaluated performance is indicated as a probability associated with each network space. The method then identifies a subset of the network spaces that has the highest probabilities, and selects a target network space from the subset based on model complexity.

### CROSS-REFERENCE TO RELATED APPLICATIONS

This application claims the benefit of U.S. Provisional Application No. 63/235,221 filed on Aug. 20, 2021, the entirety of which is incorporated by reference herein.

### TECHNICAL FIELD

Embodiments of the invention relate to neural networks; more specifically, to automatic searches for network spaces.

### BACKGROUND

Recent architectural advances in deep convolutional neural networks consider several factors for network designs (e.g., types of convolutions, network depths, filter sizes, etc.), which are combined to form a network space. One can leverage such network spaces to design favorable networks or utilize them as the search spaces for Neural Architecture Search (NAS). In industry, efficiency considerations for architectures are also required for deploying products on various platforms, such as mobile, augmented reality (AR), and virtual reality (VR) devices.

Design spaces have lately been demonstrated to be a decisive factor in designing networks. Accordingly, several design principles are proposed to deliver promising networks. However, these design principles are based on human expertise and require extensive experiments for validation. In contrast to handcrafted designs, NAS automatically searches for favorable architectures within a predefined search space. The choice of the search space is a critical factor affecting the performance and efficiency of NAS approaches. It is common to reuse tailored search spaces developed in previous works. However, these approaches ignore the potential of exploring untailored spaces. On the other hand, defining a new, effective search space involves tremendous prior knowledge and/or manual effort. Hence, there is a need for automatic network space discovery.

### SUMMARY

In one embodiment, a method is provided for network space search. The method comprises the step of partitioning an expanded search space into a plurality of network spaces. Each network space includes multiple network architectures and is characterized by a first range of network depths and a second range of network widths. The method further comprises the step of evaluating performance of the network spaces by sampling respective network architectures with respect to a multi-objective loss function. The evaluated performance is indicated as a probability associated with each network space. The method further comprises the steps of identifying a subset of the network spaces that has highest probabilities, and selecting a target network space from the subset based on model complexity.

In another embodiment, a system is provided for network space search. The system includes one or more processors, and a memory that stores instructions, when executed by the one or more processors, cause the system to partition an expanded search space into multiple network spaces. Each network space includes a plurality of network architectures and is characterized by a first range of network depths and a second range of network widths. The instructions, when executed by the one or more processors, further cause the system to evaluate performance of the network spaces by sampling respective network architectures with respect to a multi-objective loss function, wherein the evaluated performance is indicated as a probability associated with each network space; identify a subset of the network spaces that has highest probabilities; and select a target network space from the subset based on model complexity.

Other aspects and features will become apparent to those ordinarily skilled in the art upon review of the following description of specific embodiments in conjunction with the accompanying figures.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a diagram illustrating an overview of a Network Space Search (NSS) framework according to one embodiment.

FIG. 2 is a diagram illustrating a network architecture in Expanded Search Space according to one embodiment.

FIG. 3 illustrates a residual block in the network body of a network architecture according to one embodiment.

FIG. 4 is a flow diagram illustrating a method for network space search according to one embodiment.

FIG. 5 is a flow diagram illustrating a method for network space search according to another embodiment.

FIG. 6 is a block diagram illustrating a system operative to perform network space search according to one embodiment.

### DETAILED DESCRIPTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

A method and a system are provided for Network Space Search (NSS). The NSS method is performed automatically on an Expanded Search Space, which is a search space scalable with minimal assumptions in network designs. The NSS method automatically searches for Pareto-efficient network spaces in Expanded Search Space, instead of searching for a single architecture. The search for network spaces takes into account efficiency and computational costs. The NSS method is based upon differentiable approaches and incorporates multi-objectives into the search process to search for network spaces under given complexity constraints.

The network spaces output by the NSS method, named Elite Spaces, are Pareto-efficient spaces aligned with the Pareto front with respect to performance (e.g., error rates) and complexity (e.g., number of floating-point operations (FLOPs)). Moreover, Elite Spaces can further serve as NAS search spaces to improve NAS performance. Experimental results using the CIFAR-100 dataset show that NAS searches in Elite Spaces result in an average 2.3% lower error rate and 3.7% closer to target complexity than the baseline (e.g., Expanded Search Space) with around 90% fewer samples required to find satisfactory networks. Finally, the NSS method can search for superior spaces from various search spaces with different complexity, showing the applicability in unexplored and untailored spaces. The NSS method automatically searches for favorable network spaces, reducing the human expertise involved in both designing network designs and defining NAS search spaces.

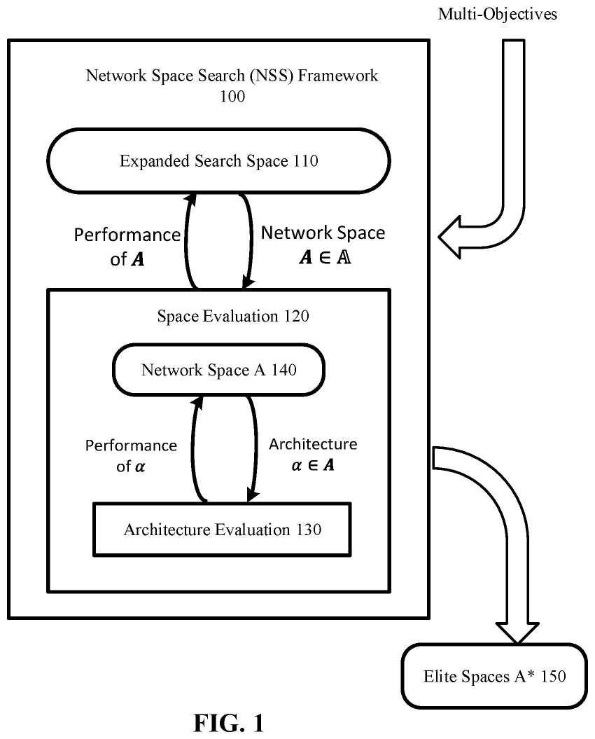

FIG. 1 is a diagram illustrating an overview of a Network Space Search (NSS) framework 100 according to one embodiment. The NSS framework 100 executes the aforementioned NSS method. During the network space searching process, the NSS method searches network spaces from Expanded Search Space 110 based on the feedback from space evaluation 120. Expanded Search Space 110 includes a large number of network spaces 140. A novel paradigm is disclosed to estimate the performance of each network space 140 by evaluating the comprised network architectures 130 based on multi-objectives. The discovered network spaces, named Elite Spaces 150, can be further utilized for designing favorable networks and served as search spaces for NAS approaches.

Expanded Search Space 110 is a large-scale space with two main properties: automatability (i.e., minimal human expertise) and scalability (i.e. capability of scaling networks). Expanded Search Space 110 serves as a search space for NSS to search for network spaces.

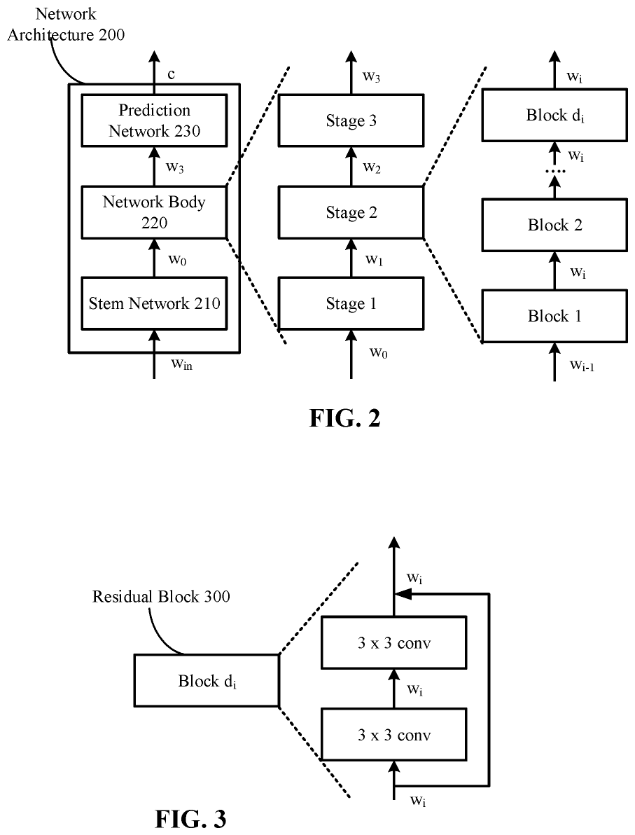

FIG. 2 is a diagram illustrating a network architecture 200 in Expanded Search Space (e.g., Expanded Search Space 110 in FIG. 1) according to one embodiment. A network architecture in Expanded Search Space includes a stem network 210, a network body 220, and a prediction network 230. The network body 220 defines network computation and determines network performance. A non-limiting example of the stem network 210 is a 3×3 convolution network. A non-limiting example of the prediction network 230 includes global average pooling followed by a fully connected layer. In one embodiment, the network body 220 includes N stages (e.g., stage 1, stage 2, and stage 3), and each stage further includes a sequence of identical blocks based on residual blocks. For each stage i (≤N), the degrees of freedom include network depths dᵢ (i.e., number of blocks) and block width wᵢ (i.e., number of channels), where dᵢ≤dₘₐₓ and wᵢ≤wₘₐₓ. Thus, Expanded Search Space includes (dₘₐₓ×wₘₐₓ)^{N} possible networks in total. Expanded Search Space allows a wide range of candidates in each degree of freedom.

FIG. 3 illustrates a residual block 300 in the network body 200 according to one embodiment. The residual block 300 includes two 3×3 convolution sub-blocks, and each convolution sub-block is followed by BatchNorm (BN) and ReLU. The block parameters, depth dᵢ and width wᵢ, are discovered by the NSS framework.

Expanded Search Space is much more complex than the conventional NAS search spaces in terms of difficulty in the selections among candidates. This is because there are dₘₐₓ possible blocks in network depths and wₘₐₓ possible channels in network widths. Moreover, Expanded Search Space can be potentially extended by replacing it with more sophisticated building blocks (e.g., complex bottleneck blocks). Thus, Expanded Search Space meets the goals of scalability in network designs and automatability with minimal human expertise.

After defining Expanded Search Space, the following question is addressed: how to search for network spaces given Expanded Search Space? To answer this, NSS is formulated as a differentiable problem of searching for an entire network space:

$${min}_{𝒜 ∈ 𝔸} {min}_{{w}_{𝒜}} ℒ ( 𝒜 , {w}_{𝒜} ) \qquad ( 1 )$$

where the optimal network space A*ϵ A is obtained from A along with its weights w_{A*} to achieve minimal loss [symbol] (A*, w_{A*}). Here A is a space without any prior knowledge imposed in network designs (e.g., Expanded Search Space). To reduce the computational cost, probability sampling is adopted and Objective (1) is rewritten to:

$${min}_{Θ} {min}_{{w}_{𝒜}} {E}_{𝒜 \sim {P}_{Θ} , 𝒜 ∈ 𝔸} [ ℒ ( 𝒜 , {w}_{𝒜} ) ] \qquad ( 2 )$$

where Θ contains parameters for sampling spaces A ϵ A. Although Objective (2), which is relaxed from Objective (1), can be used for optimization, the estimation of expected loss for each space A is still lacking. To solve this, distributional sampling is adopted to optimize (2) for the inference of super networks. A super network is a network with dₘₐₓ blocks in each stage, and wₘₐₓ channels in each block. More specifically, from a sampled space A ϵ A in (2), architectures a ϵ A are sampled to evaluate the expected loss of A. Therefore, Objective (2) is further extended accordingly:

$${min}_{Θ} {min}_{{w}_{𝒜}} {E}_{𝒜 \sim {P}_{Θ} , 𝒜 ∈ 𝔸} [ {E}_{a \sim {P}_{θ} , a ∈ 𝒜} [ ℒ ( a , {w}_{a} ) ] ] \qquad ( 3 )$$

where P_{θ} is a uniform distribution and θ contains parameters that determine the sampling probability P_{θ} of each architecture a. Objective (3) is to be optimized for network space search, and the evaluation of expected loss of a sampled space is based on (3) as well.

Instead of regarding a network space A as a set of individual architectures, A can be represented with the components in Expanded Search Space. Recalling that Expanded Search Space is composed of searchable network depths dᵢ and widths wᵢ, a network space A can therefore be viewed as a subset of all possible numbers of blocks and channels. More formally, the network space is expressed as A={dᵢ^{A} ϵ d, wᵢ^{A} ϵ w}ᵢ₌₁^{N}, where d={1, 2, . . . , dₘₐₓ}, w={1, 2, . . . , wₘₐₓ}, and dᵢ^{A} and wᵢ^{A} respectively denote the set of possible numbers of blocks and channels in A. After the searching process, dᵢ^{A} and wᵢ^{A} are retained to represent the discovered network space.

The NSS method searches for network spaces that satisfy a multi-objective loss function for further use in designing networks or defining NAS search spaces. In this way, the searched spaces enable downstream tasks to reduce the effort of refining tradeoffs and concentrate on fine-grained objectives instead. In one embodiment, the NSS method discovers networks with satisfactory tradeoffs between accuracy and model complexity. The multi-objectives search incorporates model complexity in terms of FLOPs into Objective (1) to search for network spaces fulfilling the constraints. The FLOPs loss is defined as:

[symbol]

_{FLOPs}( [symbol] )=|FLOPs( [symbol] )/FLOPs_{target}−1| (4)

where |·| denotes the absolute function and FLOPs_{target} is the FLOPs constraint to be satisfied. The multi-objective losses are combined by weighted summation, and therefore [symbol] in (1) can be replaced with the following equation:

[symbol]

( [symbol] , w [symbol] )= [symbol] ₜₐₛₖ( [symbol] , w [symbol] )+λ [symbol] _{FLOPs}( [symbol] ) (5)

where [symbol] ₜₐₛₖ is the ordinary task-specific loss in (1), which can be optimized with (3) in practice, and λ is the hyperparameter controlling the strength of FLOPs constraint.

By optimizing (5), the NSS method produces the network spaces satisfying a multi-objective loss function. Elite Spaces are derived from the optimized probability distribution P_{Θ} after the searching process. From P_{Θ}, the n spaces having the highest probabilities are sampled. The one space that is closest to the FLOPs constraint is selected as Elite Space.

To improve the efficiency of the NSS framework, weight sharing techniques can be adopted in two aspects: 1) the masking techniques can be adopted to simulate various numbers of blocks and channels by sharing a portion of the super components. 2) To ensure well-trained super networks, warmup techniques can be applied to both block and channel search.

As Expanded Search Space includes a wide range of possible network depths and widths, simply enumerating each candidate is memory-prohibited for either the kernels with various channel sizes or the stages with various block sizes. A masking technique can be used to efficiently search for channel sizes and block depths. A single super kernel is constructed with the largest possible number of channels (i.e., wₘₐₓ). Smaller channel sizes w≤wₘₐₓ is simulated by retaining the first w channels and zeroing out the remaining ones. Moreover, a single deepest stage with the largest possible number of blocks (i.e., dₘₐₓ) is constructed, and shallower block sizes d≤dₘₐₓ are simulated by taking the output of the dth block as the output of the corresponding stage. The masking technique achieves the lower bound of memory consumption and more importantly, is differential-friendly.

To provide the maximum flexibility in network space search, a super network in Expanded Search Space is constructed to have dₘₐₓ blocks in each stage and wₘₐₓ channels in each convolutional kernel. Super network weights need to be sufficiently well-trained to ensure reliable performance estimation of each candidate network space. Therefore, several warmup techniques can be used to improve the quality of super network weights. For example, in the first 25% of epochs, only the network weights are updated and network space search is disabled since network weights cannot appropriately guide the searching process in the early period.

The following description provides a non-limiting example of an experimental setup for NSS. A super network in Expanded Search Space is constructed to have dₘₐₓ=16 blocks in each stage and wₘₐₓ=512 channels in each convolutional kernel of all 3 stages. Each network space in the Expanded Search Space is defined as a continuous range of network depths and widths for simplicity. As an example, each network space includes 4 and 32 possible blocks and channels, respectively, and therefore Expanded Search Space results in (16/4)³×(512/32)³=2¹⁸ possible network spaces. A searching process is performed on the 2¹⁸ network spaces, with each network space assigned a probability according to a probability distribution. The probability assigned to each network space is updated by gradient descent. The top n network spaces having the highest probabilities are selected for further evaluation; e.g., n=5. In one embodiment, the network architectures in the n spaces are sampled. The network space having a FLOPs count closest to a predetermined FLOPs constraint is chosen as Elite Space.

The images in each of CIFAR-10 and CIFAR-100 datasets are equally split into a training set and a validation set. These two sets are used for training the super network and searching for network spaces, respectively. The batch size is set to 64. The searching process lasts for 50 epochs where the first 15 ones are reserved for warmup. The temperature for Gumbel-Softmax is initialed to 5 and linearly annealed down to 0.001 throughout the searching process. The search cost for a single run of the NSS process is roughly 0.5 days under the above settings, and the subsequent NAS performed on Expanded Search Space and Elite Spaces requires 0.5 days and merely several hours to complete a searching process, respectively.

The performance of Elite Spaces is evaluated by the performance of their comprised architectures. The NSS method sustainably discovers promising network spaces across different FLOPs constraints in both CIFAR-10 and CIFAR-100 datasets. Elite Spaces achieve satisfactory tradeoffs between the error rates and meeting the FLOPs constraints, and are aligned with the Pareto front of Expanded Search Space. Since Elite Spaces discovered by the NSS method are guaranteed to consist of superior networks provided in various FLOPs regimes, they can be utilized for designing promising networks. More importantly, Elite Spaces are searched by NSS automatically, therefore the human effort involved in network designs is significantly reduced.

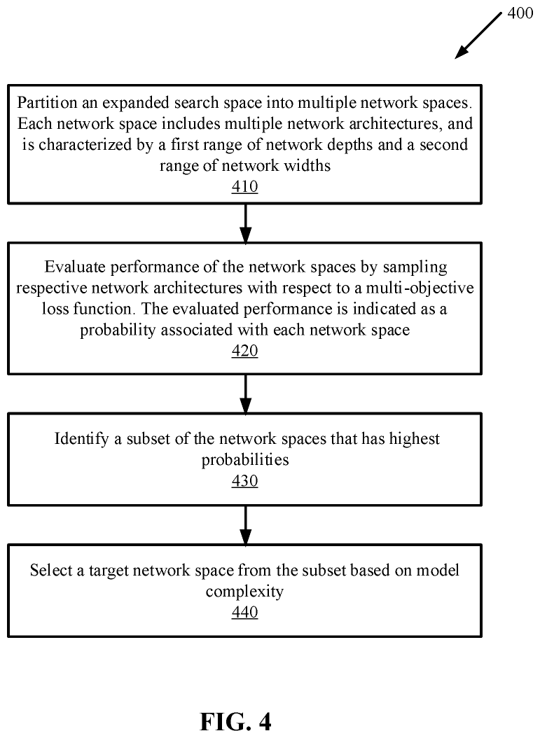

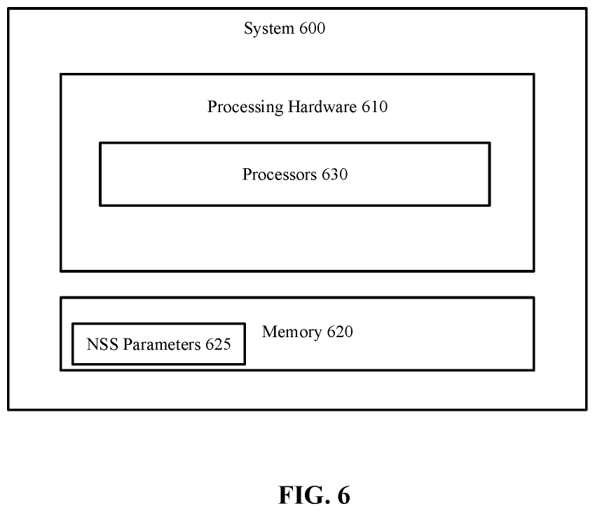

FIG. 4 is a flow diagram illustrating a method 400 for network space search according to one embodiment. The method 400 may be performed by a computing system, such as a system 600 to be described with reference to FIG. 6. The system at step 410 partitions an expanded search space into multiple network spaces, with each network space including multiple network architectures. Each network space is characterized by a first range of network depths and a second range of network widths.

The system at step 420 evaluates the performance of the network spaces by sampling respective network architectures with respect to a multi-objective loss function. The evaluated performance is indicated as a probability associated with each network space. The system at step 430 identifies a subset of the network spaces that has the highest probabilities. The system at step 440 selects a target network space from the subset based on model complexity. In one embodiment, the target network space selected at step 440 is referred to as Elite network space.

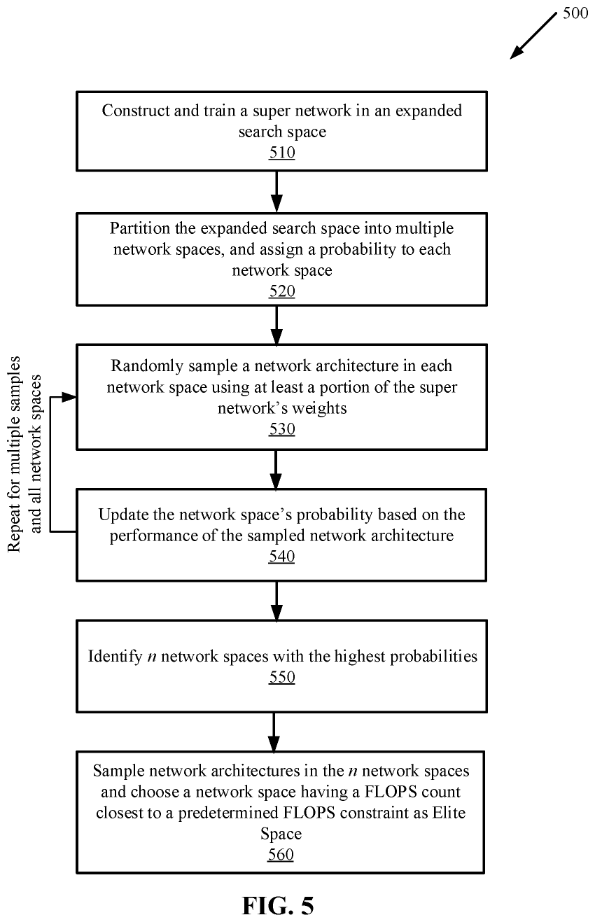

FIG. 5 is a flow diagram illustrating a method 500 for network space search according to another embodiment, which may be an example of the method 400 in FIG. 4. The method 500 may be performed by a computing system, such as a system 600 to be described with reference to FIG. 6. The system at step 510 constructs and trains a super network in an expanded search space. The system at step 520 partitions the expanded search space into multiple network spaces, and assigns a probability to each network space. Steps 530 and 540 are repeated for multiple samples of a network space, and are also repeated for all network spaces. The system at step 530 randomly samples a network architecture in each network space using at least a portion of the super network's weights. The system at step 540 updates the network space's probability based on the performance of the sampled network architecture. The performance may be measured by the aforementioned multi-objective loss function. Furthermore, Gumbel-Softmax may be used to calculate a gradient vector of the probability of each network space. Gumbel-Softmax enables parallel optimization of subspace optimization and network optimization to reduce computational cost. The system at step 550 identifies n network spaces with the highest probabilities. At step 560, the system samples network architectures in the n network spaces and chooses a network space having a FLOPS count closest to a predetermined FLOPS constraint as Elite Space.

FIG. 6 is a block diagram illustrating a system 600 operative to perform network space search according to one embodiment. The system 600 includes processing hardware 610 which further includes one or more processors 630 such as central processing units (CPUs), graphics processing units (GPUs), digital processing units (DSPs), neural processing units (NPUs) 635, field-programmable gate arrays (FPGAs), and other general-purpose processors and/or special-purpose processors.

The processing hardware 610 is coupled to a memory 620, which may include memory devices such as dynamic random access memory (DRAM), static random access memory (SRAM), flash memory, and other non-transitory machine-readable storage media; e.g., volatile or non-volatile memory devices. To simplify the illustration, the memory 620 is represented as one block; however, it is understood that the memory 620 may represent a hierarchy of memory components such as cache memory, system memory, solid-state or magnetic storage devices, etc. The processing hardware 610 executes instructions stored in the memory 620 to perform operating system functionalities and run user applications. For example, the memory 620 may store NSS parameters 625, which may be used by method 400 in FIG. 4 and method 500 in FIG. 5 to execute network space searches.

In some embodiments, the memory 620 may store instructions which, when executed by the processing hardware 610, cause the processing hardware 610 to perform image refinement operations according to method 400 in FIG. 4 and method 500 in FIG. 5.

The operations of the flow diagrams of FIGS. 4 and 5 have been described with reference to the exemplary embodiment of FIG. 6. However, it should be understood that the operations of the flow diagrams of FIGS. 4 and 5 can be performed by embodiments of the invention other than the embodiment of FIG. 6 and the embodiment of FIG. 6 can perform operations different than those discussed with reference to the flow diagram. While the flow diagrams of FIGS. 4 and 5 show a particular order of operations performed by certain embodiments of the invention, it should be understood that such order is exemplary (e.g., alternative embodiments may perform the operations in a different order, combine certain operations, overlap certain operations, etc.).

Various functional components, blocks, or modules have been described herein. As will be appreciated by persons skilled in the art, the functional blocks or modules may be implemented through circuits (either dedicated circuits or general-purpose circuits, which operate under the control of one or more processors and coded instructions), which will typically comprise transistors that are configured in such a way as to control the operation of the circuity in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for network space search, comprising:
partitioning an expanded search space into a plurality of network spaces, wherein each network space includes a plurality of network architectures and is characterized by a first range of network depths and a second range of network widths;
evaluating performance of the network spaces by sampling respective network architectures with respect to a multi-objective loss function, wherein the evaluated performance is indicated as a probability associated with each network space;
identifying a subset of the network spaces that has highest probabilities; and
selecting a target network space from the subset based on model complexity.

2. The method of claim 1, wherein each network architecture in the expanded network space includes a stem network to receive an input, a prediction network to generate an output, and a network body that includes the predetermined number of stages.

3. The method of claim 1, wherein the multi-objective loss function includes a task-specific loss function and a model complexity function.

4. The method of claim 3, wherein the model complexity function calculates complexity of a network architecture in terms of the number of floating-point operations (FLOPs).

5. The method of claim 3, wherein the model complexity function calculates a ratio of a network architecture's floating-point operations (FLOPs) to a predetermined FLOPs constraint.

6. The method of claim 1, wherein selecting the target network space further comprises:
choosing the target network space that has a floating-point operations (FLOPs) count closest to a predetermined FLOPS constraint.

7. The method of claim 1, wherein each network architecture includes a predetermined number of stages, each stage including d blocks and each block including w channels, wherein each network space is characterized by a first range of d values and a second range of w values.

8. The method of claim 1, wherein each block is a residual block including two convolution sub-blocks.

9. The method of claim 1, further comprising:
training a super network with a maximum network depth and a maximum network width to obtain weights; and
sampling the network architectures in each network space using at least a portion of the weights of the super network.

10. The method of claim 1, wherein evaluating the performance further comprises:
optimizing a probability distribution over the network spaces.

11. A system operative to perform network space search, comprising:
one or more processors; and
memory to store instructions, when executed by the one or more processors, cause the system to:
partition an expanded search space into a plurality of network spaces, wherein each network space includes a plurality of network architectures and is characterized by a first range of network depths and a second range of network widths;
evaluate performance of the network spaces by sampling respective network architectures with respect to a multi-objective loss function, wherein the evaluated performance is indicated as a probability associated with each network space;
identify a subset of the network spaces that has highest probabilities; and
select a target network space from the subset based on model complexity.

12. The system of claim 11, wherein each network architecture in the expanded network space includes a stem network to receive an input, a prediction network to generate an output, and a network body that includes the predetermined number of stages.

13. The system of claim 11, wherein the multi-objective loss function includes a task-specific loss function and a model complexity function.

14. The system of claim 13, wherein the model complexity function calculates complexity of a network architecture in terms of the number of floating-point operations (FLOPs).

15. The system of claim 13, wherein the model complexity function calculates a ratio of a network architecture's floating-point operations (FLOPs) to a predetermined FLOPs constraint.

16. The system of claim 11, wherein the instructions, when executed by the one or more processors, cause the system to:
choose the target network space that has a floating-point operations (FLOPs) count closest to a predetermined FLOPS constraint.

17. The system of claim 11, wherein each network architecture includes a predetermined number of stages, each stage including d blocks and each block including w channels, wherein each network space is characterized by a first range of d values and a second range of w values.

18. The system of claim 11, wherein each block is a residual block including two convolution sub-blocks.

19. The system of claim 11, wherein the instructions, when executed by the one or more processors, cause the system to:
train a super network with a maximum network depth and a maximum network width to obtain weights; and
sample the network architectures in each network space using at least a portion of the weights of the super network.

20. The system of claim 11, wherein the instructions, when executed by the one or more processors, cause the system to:
optimize a probability distribution over the network spaces.
